(19) United States
(12) Patent Application Publication
(10) Pub. No.: US 2011/0135374 A1
(43) Pub. Date: Jun. 9, 2011

(54) RECORDING APPARATUS

(75) Inventors: Toshihide Wada, Yokohama-shi (JP); Hiroyuki Saito, Yokohama-shi (JP); Shinya Asano, Tokyo (JP); Hiroyuki Kinoshita, Kawasaki-shi (JP); Takashi Awai, Chiba-shi (JP); Makoto Takemura, Tokyo (JP)

(73) Assignee: CANON KABUSHIKI KAISHA, Tokyo (JP)

(21) Appl. No.: 12/949,141

(22) Filed: Nov. 18, 2010

(30) Foreign Application Priority Data
Dec. 9, 2009 (JP) 2009-279317

(51) Int. Cl. B41J 11/00

(52) U.S. Cl. 400/624

(57) ABSTRACT

A recording apparatus having a function of sorting recording sheets is reduced in size and cost. The recording apparatus conveys the recording sheets, records on the recording sheets, discharges the recording sheets, and sorts the discharged recording sheets. The recording apparatus includes: a movable carriage that holds a recording head for recording on the recording sheets; and a sorting mechanism that controls positions of the recording sheets so that the discharged recording sheets are sorted, and the sorting mechanism is configured to be operated by the carriage and sort the recording sheets in accordance with a position of the carriage.

### BACKGROUND OF THE INVENTION

1. Field of the Invention

The present invention relates to a recording apparatus that conveys, sorts, and discharges recording sheets.

2. Description of the Related Art

Recording apparatuses that convey recording sheets and record on the recording sheets include a printing apparatus and a printer. In recent years, a printing apparatus as a recording apparatus has a function of sorting prints (recording sheets) so that the prints discharged after printing are easily taken out.

A large printing apparatus includes a plurality of discharge trays. In this case, recording sheets are sorted by switching trays to which the recording sheets are discharged. Meanwhile, in a small printing apparatus, recording sheets are sorted by discharging the recording sheets to one tray, and displacing positions of the discharged recording sheets.

An image forming apparatus having a function of sorting recording sheets by displacing discharge positions of the recording sheets is disclosed in Japanese Patent Application Laid-Open No. 2005-132611. In the image forming apparatus, a roller in a discharge portion that discharges the recording sheets conveys the recording sheets in a conveying direction, and the roller is moved orthogonally to the conveying direction. The movement of the roller displaces the position of the delivered recording sheets. A dedicated power source is used for the movement of the roller orthogonal to the conveying direction.

Japanese Patent Application Laid-Open No. 2004-269091 discloses a recording paper (recording sheet) discharging apparatus having a different sorting mechanism. This discharging apparatus moves a paper discharge tray for sequentially stacking discharged recording papers to a predetermined position, and thus sorts the discharged recording papers. A dedicated power source is used for the movement of the paper discharge tray.

The apparatuses described in Japanese Patent Application Laid-Open Nos. 2005-132611 and 2004-269091 each use the dedicated power source for sorting the discharged sheets. This increases size and cost of the apparatuses.

### SUMMARY OF THE INVENTION

In view of the problems of the background art, the present invention has an object to provide a recording apparatus that has a function of sorting discharged recording sheets, and can reduce size and cost.

The present invention provides a recording apparatus that conveys recording sheets, records on the recording sheets, discharges the recording sheets, and sorts the discharged recording sheets. The recording apparatus includes: a movable carriage that holds a recording head for recording on the recording sheets; and a sorting mechanism that controls positions of the recording sheets so that the discharged recording sheets are sorted, and the sorting mechanism is configured to be operated by the carriage and sort the recording sheets in accordance with a position of the carriage.

According to the present invention, there is no need for a dedicated power source for sorting the recording sheets, and size and cost of the recording apparatus can be reduced.

Further features of the present invention will become apparent from the following description of exemplary embodiments with reference to the attached drawings.

### BRIEF DESCRIPTION OF THE DRAWINGS

FIG. 1 is a schematic perspective view of a printing apparatus according to a first embodiment of the present invention.

FIG. 2 is a schematic perspective view illustrating an internal configuration of the printing apparatus in FIG. 1.

FIG. 3 is an enlarged view of a part provided with a carriage and therearound of the printing apparatus in FIG. 2.

FIG. 4 is a schematic sectional view of the printing apparatus taken along the line IV-IV in FIG. 3.

FIG. 5 is an enlarged schematic plan view of an area V in FIG. 3.

FIG. 6 is a schematic plan view illustrating an internal configuration of the printing apparatus in one operation state.

FIG. 7 is an enlarged schematic plan view of around a lock mechanism in the printing apparatus in the same operation state as in FIG. 6.

FIG. 8 is a schematic plan view illustrating the printing apparatus in another operation state.

FIG. 9 is an enlarged schematic plan view of around the lock mechanism in the printing apparatus in the same operation state as in FIG. 8.

FIGS. 10A and 10B are schematic plan views illustrating an internal configuration of the printing apparatus in a further operation state.

FIG. 11 is a schematic diagram illustrating a state where discharged printing sheets are sorted.

FIG. 12 is a control block diagram of the printing apparatus illustrated in FIG. 1.

FIG. 13 is a schematic perspective view illustrating a printing apparatus according to a second embodiment of the present invention.

FIG. 14 is a schematic perspective view illustrating a printing apparatus according to a third embodiment of the present invention.

### DESCRIPTION OF THE EMBODIMENTS

Now, embodiments of the present invention will be described with reference to the drawings. In the embodiments below, as a recording apparatus of the present invention, a printing apparatus that prints on a printing sheet as a recording sheet will be described, but the present invention can be applied to general recording apparatuses that sort and discharge recording sheets. As the recording sheets, various sheets such as paper or plastic sheets are used.

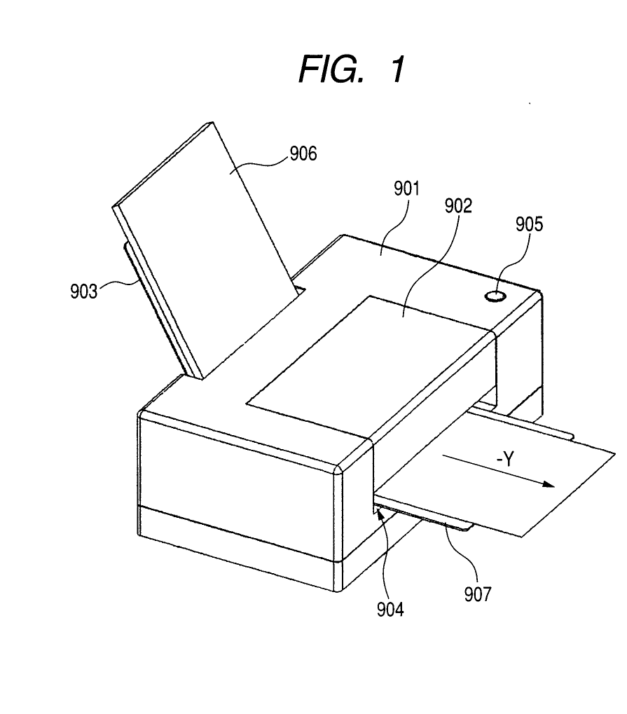

FIG. 1 is a schematic perspective view of a printing apparatus according to one embodiment of the present invention. The printing apparatus includes a casing cover 901, a maintenance cover 902, a feeding guide (supplying stacking mechanism) 903 that stack and holds printing sheets (recording sheets) 906 before conveyed, and a discharge port 904 from which printed (recorded) printing sheets 906 are discharged. The printing sheets 906 are discharged in an arrow direction (−Y direction) in FIG. 1, and the discharged printing sheets 906 are stacked on a discharge tray (discharging stacking mechanism) 907. The printing apparatus includes a power switch 905.

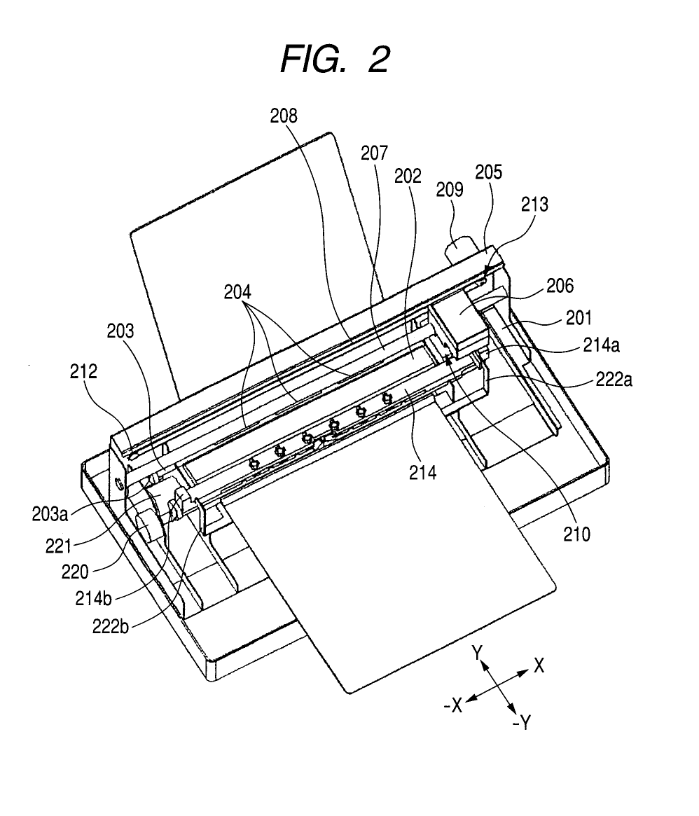

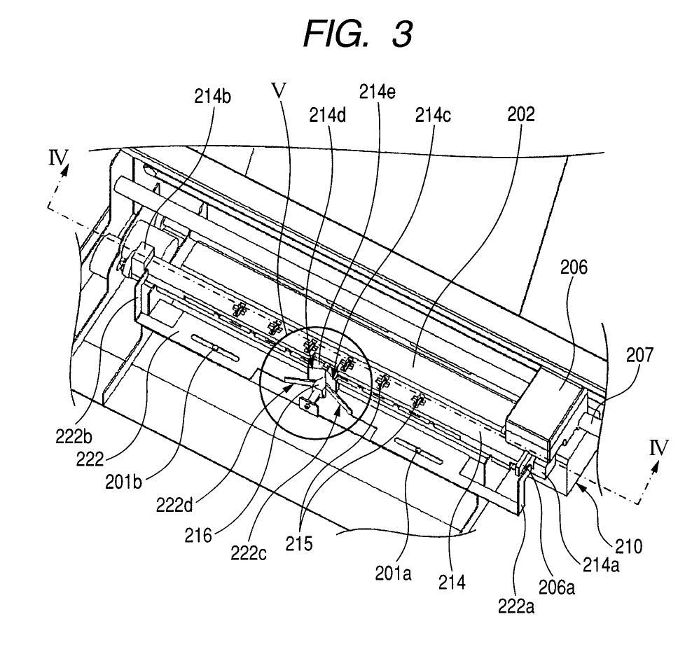

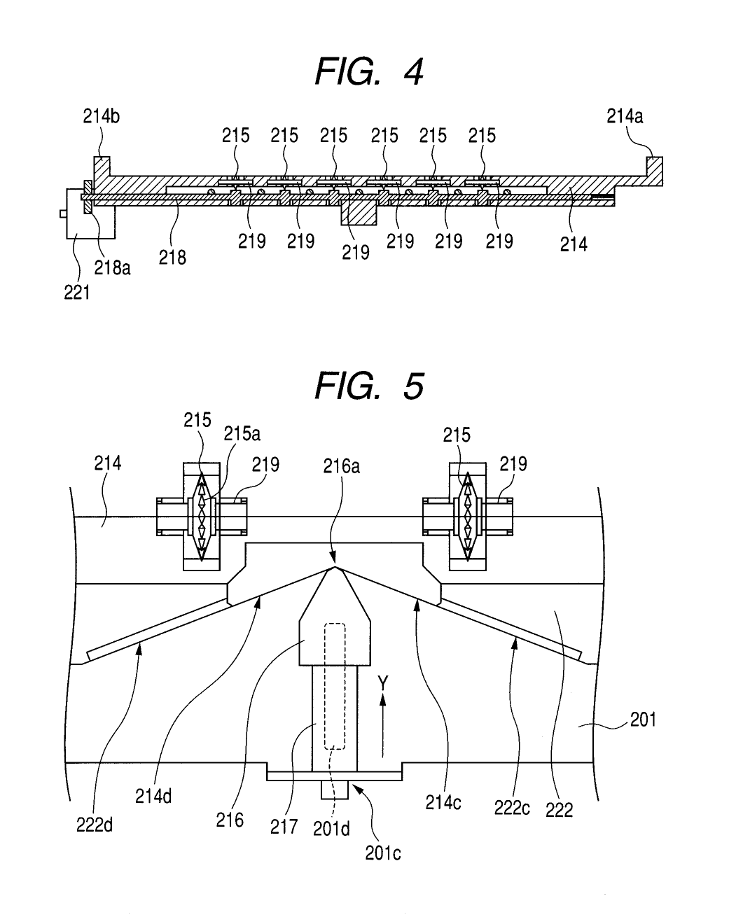

FIG. 2 is a schematic perspective view illustrating an internal configuration of the printing apparatus. FIG. 3 is an enlarged schematic perspective view of an internal configuration of a carriage and therearound of the printing apparatus. FIG. 4 is a schematic sectional view of the printing apparatus taken along the line IV-IV in FIG. 3. FIG. 5 is an enlarged schematic plan view of an area V in FIG. 3.

The printing apparatus includes a chassis 201 that supports a component in a casing, a platen 202 that supports a printing sheet 906 during printing, and a roller 203 and a pinch roller 204 that feed the printing sheet 906. The pinch roller 204 is pressed against the roller 203 by an unshown holder or spring. Thus, the printing sheet 906 is held between the roller 203 and the pinch roller 204. A sheet feed motor 220 that drives the roller 203 transmits a drive force to the roller 203 via an idler gear 221 and a roller gear 203a and rotates the roller 203. Thus, the printing sheet 906 is fed in the −Y direction in FIG. 2.

A carriage 206 is supported reciprocatably in X and −X directions along a guide portion 205 and a guide shaft 207 formed in the chassis 201. A carriage motor 209 drives the carriage 206 via a belt 208, and causes the carriage 206 to reciprocate along the guide shaft 207 and the guide portion 205. The belt 208 extends between a pulley 213 pivoted by the carriage motor 209 and an idle pulley 212, and a part of the belt 208 is connected to the carriage 206.

The printing apparatus can include a maintenance mechanism 210 held by the carriage 206 for maintaining a recording mechanism that records on the printing sheet 906. In this embodiment, an inkjet recording head is used as the recording mechanism. The recording head is not limited to the inkjet recording head, but various known heads may be used.

Electric power and a signal to the recording head held by the carriage 206 are transmitted via an unshown cable to the carriage 206 and transmitted from the carriage 206 to the recording head. A printing operation is generally performed on the printing sheet 906 placed on the platen 202.

The printing apparatus includes a conveying mechanism that conveys the printing sheet 906. As described later, in the first embodiment, the conveying mechanism is a sorting mechanism that sorts the printing sheets. The conveying mechanism includes a delivery roller 218 and a spur roller 215 that follows the delivery roller. The printing sheet 906 immediately after printing is held between the delivery roller 218 and the spur roller 215 and conveyed. The spur roller 215 has a claw portion 215a in a part in contact with the printing sheet 906, and the claw portion 215a is sharp but does not damage the printing sheet 906. A spur holder 214 that supports the spur roller 215 is supported by the chassis 201 reciprocatably in the X and −X directions.

The printing apparatus includes a lock mechanism that secures the spur holder 214 in a predetermined reference position so that the spur holder 214 is not moved, for example, during a recording operation. The lock mechanism secures the sorting mechanism inoperably in the predetermined reference position so that the sorting mechanism is not moved during the recording operation.

Specifically, the lock mechanism includes a lock pin 216, and a lock pin releasing cam plate 222. The lock pin 216 is guided by a guide groove 201d and a guide hole 201c formed in the chassis 201. A lock pin spring 217 urges the lock pin 216 in a Y direction in the drawing.

A contact portion 214e formed by two slopes 214c and 214d into a V shape is formed in the spur holder 214. When a top 216a of the lock pin 216 is pressed into an apex of the V-shaped contact portion 214e, the spur holder 214 is immovably secured.

The drive force of the sheet feed motor 220 is transmitted to the delivery roller 218 by the delivery roller gear 218a engaging the idler gear 221.

The spur roller 215 is urged by a spring shaft 219, and presses the printing sheet 906 against the delivery roller 218. Thus, by simply driving the delivery roller 218, the spur roller 215 follows the delivery roller 218, thereby allowing the printing sheet 906 to be discharged.

The lock pin releasing cam plate 222 has openings along the X and −X directions, and guide pins 201a and 201b formed in the chassis 201 are inserted into the openings. As such, the lock pin releasing cam plate 222 is configured to be reciprocatable in the X and −X directions.

A contact portion formed by two slopes 222c and 222d into a V shape is formed in the lock pin releasing cam plate 222. An angle between the two slopes 222c and 222d is the same as an angle of the V-shaped contact portion 214e formed in the spur holder 214.

The contact portion 214e of the spur holder and the contact portion of the lock pin releasing cam plate 222 are aligned in a predetermined reference position. When the top 216a of the lock pin 216 is pressed into an apex of the contact portions, the spur holder 214 and the lock pin releasing cam plate 222 are secured.

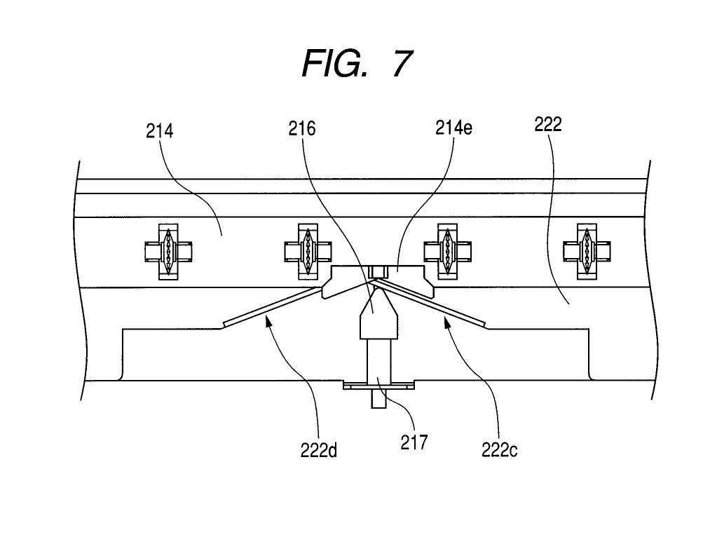

In the reciprocating directions of the lock pin releasing cam plate 222, abutment portions 222a and 222b are formed at opposite ends of the lock pin releasing cam plate 222. When the carriage 206 is moved to the outside of a printing (recording) range on the printing sheet, or the outside of the position of the maintenance mechanism 210, a carriage lever 206a provided in the carriage 206 abuts against the abutment portion 222a or 222b of the lock pin releasing cam plate 222. When the carriage 206 is further moved to the outside in a moving direction, the carriage 206 presses the abutment portions 222a and 222b of the lock pin releasing cam plate 222, and moves the lock pin releasing cam plate 222 in the same direction as the direction of the carriage 206 (direction orthogonal to a conveying direction of the printing sheet). Thus, the two slopes 222c and 222d of the lock pin releasing cam plate 222 and the lock pin 216 are misaligned, and the two slopes 222c and 222d press the lock pin 216 in the −Y direction. As such, a gap is created between the contact portion 214e of the spur holder 214 and the lock pin 216, thus the securing of the spur holder 214 is released, and the spur holder 214 is made movable (also see FIG. 7).

Meanwhile, the spur holder 214 also has abutment portions 214a and 214b that abut against the carriage 206. The carriage 206 presses the abutment portions 214a and 214b to move the spur holder 214 in the same direction as the direction of the carriage 206.

The carriage 206 first moves the lock pin releasing cam plate 222 and then moves the spur holder 214. Specifically, the lock mechanism makes the sorting mechanism operable when the carriage 206 is located outside a first position, which is outside a recording area where the recording head records on the recording sheet 906. Further, the sorting mechanism is operated when the carriage 206 is located further outside a second position, which is outside the first position. Thus, the spur holder 214 can be moved after the securing of the spur holder 214 is released.

As described above, the lock mechanism is operated by the carriage 206, and makes the sorting mechanism operable in accordance with the position of the carriage 206. This eliminates the need for a dedicated driving source for driving the lock mechanism.

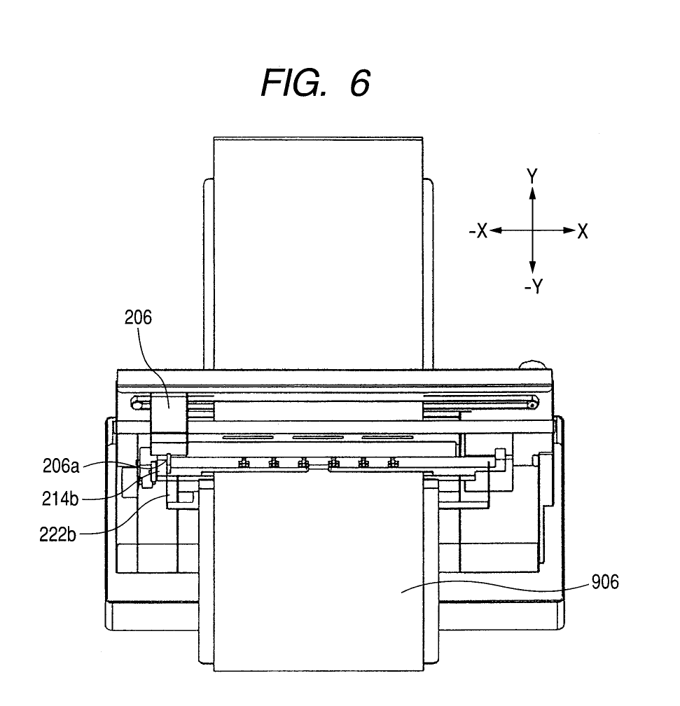

Now, the operation of the printing apparatus when the sorting mechanism is operated will be described in more detail. FIG. 6 illustrates a state where a printing operation is finished and an upstream side end in a sheet conveying direction of the printing sheet 906 is held between the delivery roller 218 and the spur roller 215. FIG. 7 is an enlarged schematic view illustrating the lock mechanism and therearound in this state. When the recording head held by the carriage 206 is moved in the −X direction beyond an area for recording (recording area), the carriage lever 206a presses the abutment portion 222b of the lock pin releasing cam plate 222. In the state illustrated in FIGS. 6 and 7, the carriage 206 is further moved and in contact with the abutment portion 214b of the spur holder 214.

As illustrated in FIG. 6, if the printing sheet 906 is conveyed in a state where the carriage 206 does not operate the sorting mechanism, the printing sheet 906 is discharged to a predetermined reference position.

The lock pin releasing cam plate 222 is moved in the −X direction with the movement of the carriage 206, the slope 222c of the lock pin releasing cam plate 222 presses the lock pin 216 in the −Y direction. Thus, the spur holder 214 is unlocked and made movable (see FIG. 7).

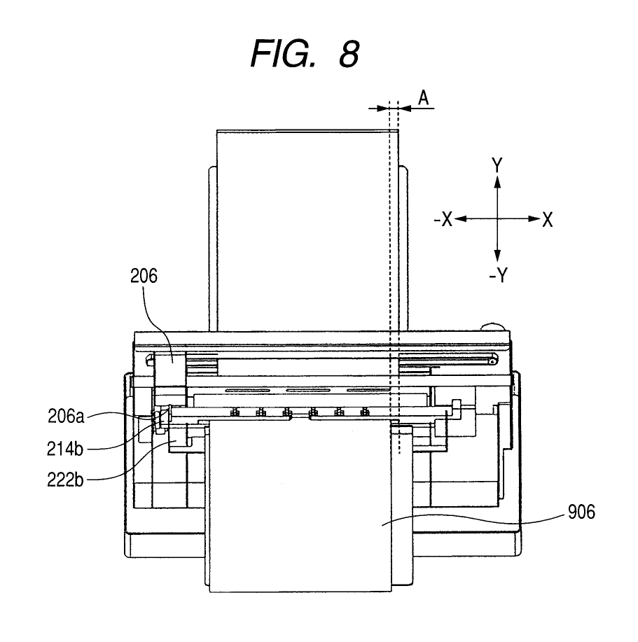

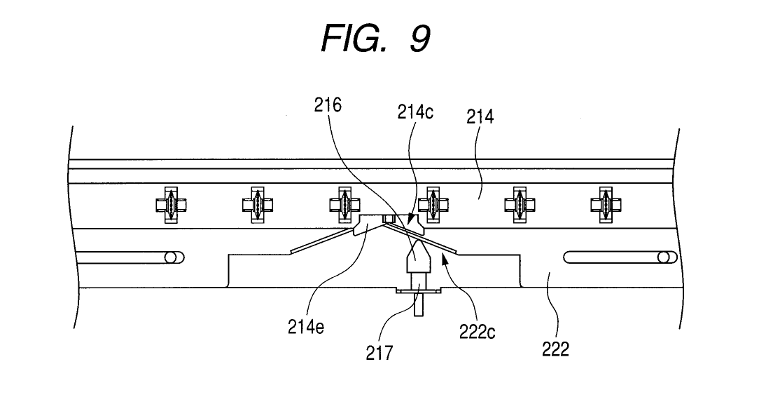

FIG. 8 illustrates a state where the carriage 206 is further moved in the −X direction from the state illustrated in FIGS. 6 and 7. FIG. 9 is an enlarged schematic view illustrating the lock mechanism and therearound in this state. The carriage lever 206a presses the abutment portion 214b of the spur holder 214, and the spur holder 214 is displaced from its original position by an amount of movement A of the carriage 206 after the contact of the carriage lever 206a with the abutment portion 214b. At this time, the delivery roller 218, the delivery roller gear 218a, and the spur roller 215 formed in the spur holder 214 are moved together. With this movement, the discharge position of the printing sheet 906 held between the delivery roller 218 and the spur roller 215 is also displaced.

With the movement of the spur holder 214, the lock pin releasing cam plate 222 is also moved, and the slope 222c of the lock pin releasing cam plate 222 further presses the lock pin 216 in the −Y direction. In this state, there is a gap between the slope 214c of the V-shaped contact portion 214e of the spur holder 214 and the lock pin 216, and thus the lock pin 216 does not control the movement of the spur holder 214.

The idler gear 221 that engages with the delivery roller gear 218a has a wide face width, allowing for the amount of displacement. Thus, even if the delivery roller gear 218a is moved together with the spur holder 214, the delivery roller gear 218a can be kept engaging with the idler gear 221. As such, interruption of transmission of power is prevented.

In this state, the sheet feed motor 220 is driven, the delivery roller 218 is rotated to discharge the printing sheet 906, and stack the printing sheet 906 on the discharge tray 907.

As described above, the position of the discharged printing sheet 906 is displaced between when the printing sheet 906 is discharged with the sorting mechanism being operated and when the printing sheet 906 is discharged without the sorting mechanism being operated (see FIG. 8). As such, the printing sheets 906 can be sorted.

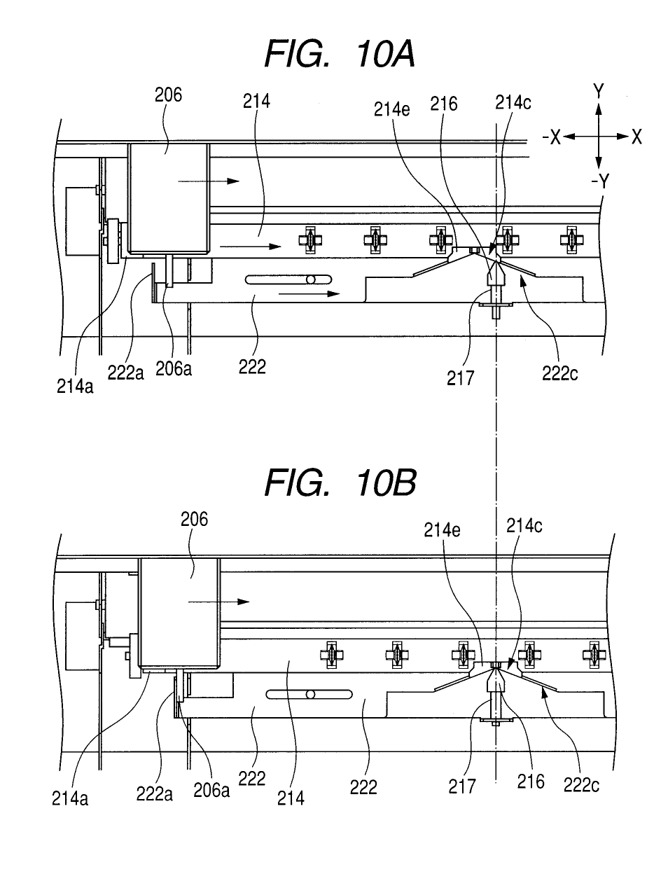

FIGS. 10A and 10B illustrate an operation of the lock mechanism after discharge of the sheet. FIG. 10A illustrates a state immediately after the discharge of the printing sheet 906. After the discharge of the sheet is finished, the carriage 206 is moved from an end in the −X direction to the X direction. Thus, the carriage lever 206a is moved away from the abutment portion 214b of the spur holder 214 and the abutment portion 222b of the lock pin releasing cam plate 222.

The lock pin 216 is pressed in the Y direction by the lock pin spring 217. Thus, the lock pin 216 presses the slope 222c formed in the lock pin releasing cam plate 222. Thus, the lock pin releasing cam plate 222 is moved in the X direction. Further, the lock pin 216 presses the slope 214c formed in the spur holder 214. Thus, the spur holder 214 is also moved in the X direction.

Finally, the lock pin 216 is pressed into the apex of the V-shaped contact portion 214e of the spur holder 214, and the apex of the V-shaped contact portion of the lock pin releasing cam plate 222. As such, the spur holder 214 and the lock pin releasing cam plate 222 are secured in the original reference position (see FIG. 10B).

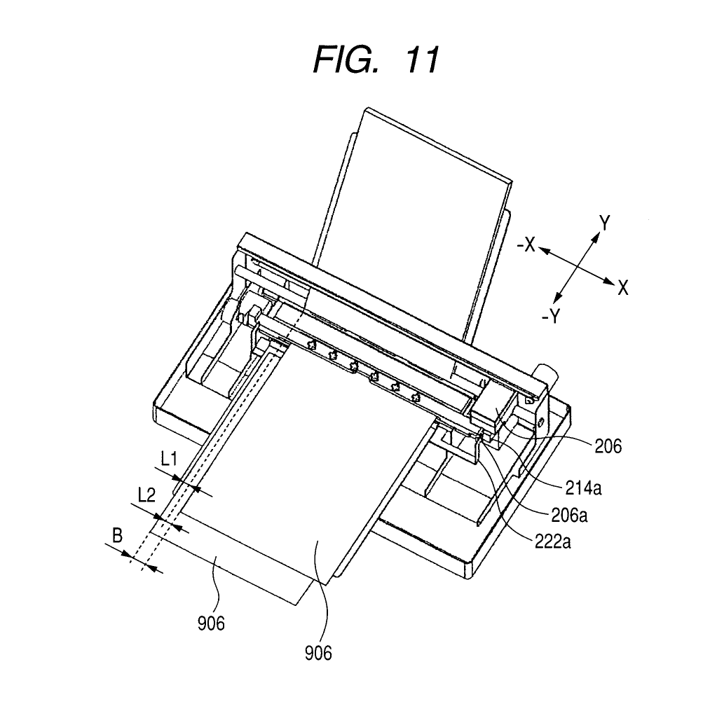

FIG. 11 illustrates a state where the carriage 206 is moved in the X direction to sort the printing sheets unlike the above case. The printing apparatus can be configured to sort the sheets when the carriage is moved in one direction (−X direction) and also in the opposite direction (X direction). Thus, the printing sheets 906 can be discharged in a displaced manner in opposite directions. Specifically, one printing sheet 906 can be displaced in the X direction from a predetermined reference position by a predetermined distance L2, and another printing sheet can be displaced in the −X direction from the predetermined reference position by a predetermined distance L1. In this case, the discharged and stacked printing sheets 906 are displaced by the sum of the distances L1 and L2 (corresponding to a distance B in the drawing) at the maximum. As such, the maximum value of the amount of displacement of the discharged printing sheets is increased, thereby allowing the printing sheets to be clearly sorted or sorted into many sections. The printing sheets are displaced in the same range as a moving distance of the spur holder 214.

In the embodiment, the position of the carriage 206 can be adjusted to adjust the position of the spur holder 214. As such, a plurality of discharge positions of the printing sheets 906 can be selected, and the printing sheets 906 can be sorted into a plurality of positions.

In this embodiment, the carriage 206 is moved to the outside of the printing range in order to move the spur holder 214. However, not limited to this, a portion moved with the movement of the spur holder 214 is provided in a part of a mechanism for adjusting a distance between the recording head for recording on the sheet and the sheet, and thus the sheets can be sorted without extending the movement range of the carriage 206 to the outside of the recording range.

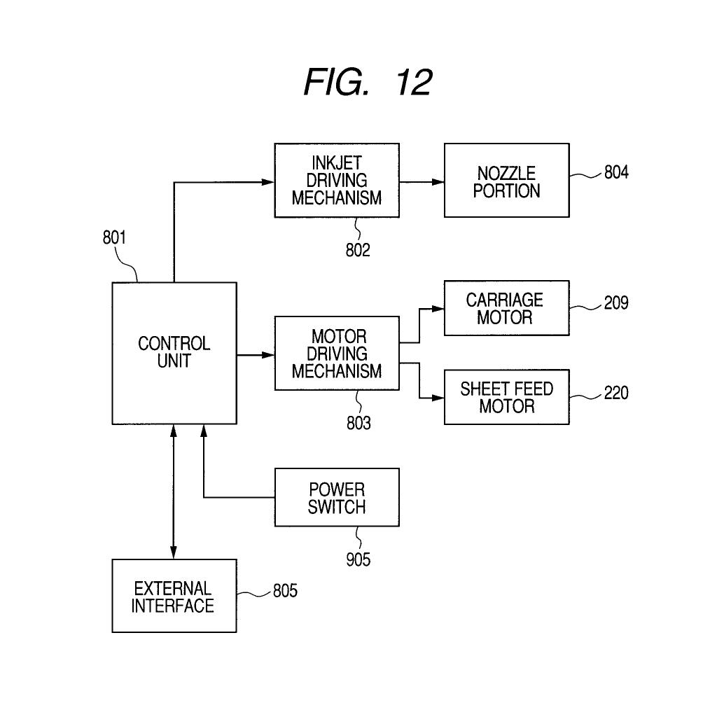

FIG. 12 is a block diagram illustrating an example of a control block of the printing apparatus of this embodiment. A control unit 801 that controls the entire printing apparatus transmits printing information output/input via an external interface 805, via an inkjet driving mechanism 802 to an inkjet nozzle portion 804. The nozzle portion 804 receives the signal and ejects ink. The control unit 801 drives the carriage motor 209 and the sheet feed motor 220 via a motor driving mechanism 803. A signal from a power switch 905 is transmitted to the control unit 801. In this embodiment, the control unit 801 controls so that the carriage 206 operates the sorting mechanism between when the recording head held by the carriage 206 records on the printing sheet 906 and when the printing sheet 906 is discharged.

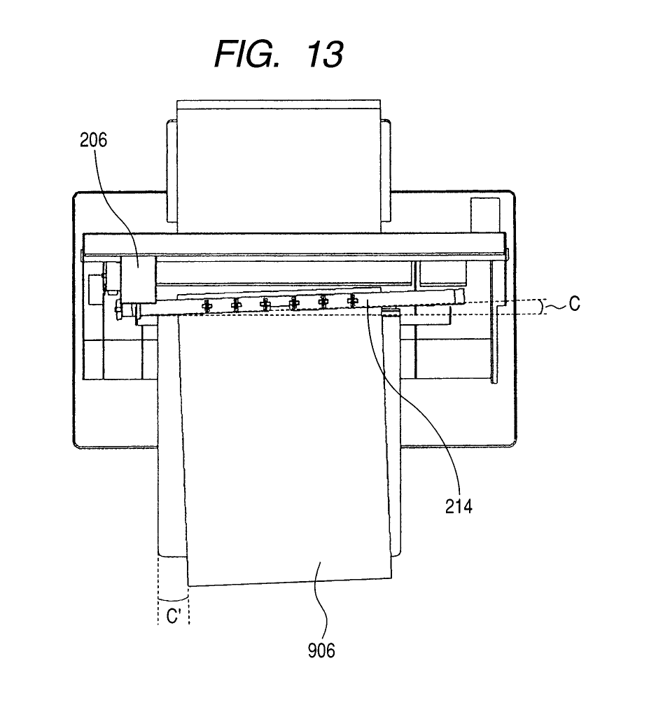

FIG. 13 illustrates a printing apparatus according to a second embodiment of the present invention. Also in the printing apparatus according to the second embodiment, the sorting mechanism includes a conveying mechanism including a pair of conveying rollers (delivery roller and spur roller) that hold and convey printing sheets 906. A carriage 206 operates a spur holder 214 that constitutes the conveying mechanism, and pivots the spur holder 214 around a predetermined pivot shaft orthogonal to the printing sheet 906. With this pivot, the printing sheets 906 are also pivoted. Thus, a discharge position of the printing sheets 906 can be controlled to sort the printing sheets 906. FIG. 13 illustrates a state where the spur holder 214 and the printing sheet 906 are pivoted by an angle C from a reference direction. Also in the second embodiment, the sorting mechanism is operated by the carriage 206 pressing an abutment portion provided in the spur holder 214. The second embodiment also can include the same lock mechanism as in the first embodiment.

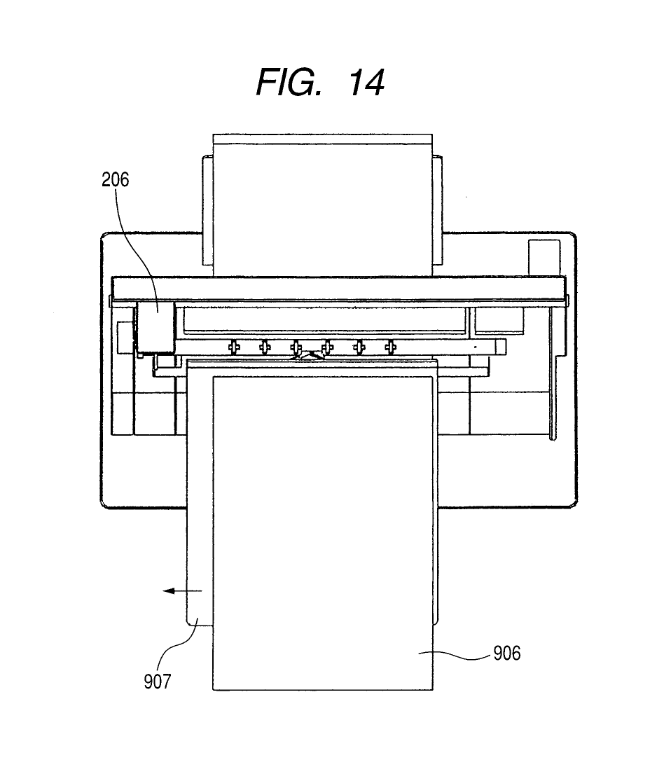

FIG. 14 illustrates a printing apparatus according to a third embodiment of the present invention. In the printing apparatus according to the third embodiment, the sorting mechanism includes a discharge tray (discharging stacking mechanism) 907 that stacks and holds discharged printing sheets 906. In the printing apparatus, a carriage 206 moves the discharge tray 907, and the printing sheets 906 are discharged on the moved discharge tray 907. The discharge tray 907 is displaced to a predetermined position before discharge, thereby allowing the printing sheets 906 to be sorted. As an example, the discharging stacking mechanism includes an abutment portion against which the carriage 206 can abut as in the above embodiment, and the carriage 206 presses the abutment portion. Thus, the discharging stacking mechanism is moved orthogonally to a conveying direction of the printing sheet 906 (in a direction shown by the arrow in the drawing). The third embodiment also can include the same lock mechanism as in the first embodiment.

As a fourth embodiment, for example, a supplying stacking mechanism such as an automatic feeding apparatus or a media cassette may be moved that stacks and holds printing sheets before conveyed. Specifically, the sorting mechanism includes the supplying stacking mechanism. In this case, the control unit 801 described in the first embodiment controls so that the carriage operates the sorting mechanism and changes conveying positions of the printing sheets when recording sheets are conveyed from the supplying stacking mechanism. The control unit can control so that a recording area where a recording head held by the carriage records is changed in accordance with an amount of change of the conveying position of the printing sheet. Thus, even if the position of the printing sheet before recording is changed, printing can be performed in a predetermined position on the sheet. The fourth embodiment also can include the same lock mechanism as in the first embodiment.

As described in the embodiments, the sorting mechanism controls the positions of the printing sheets so that the discharged printing sheets can be sorted. The sorting mechanism is configured to be operated by the carriage and sort the recording sheets in accordance with the position of the carriage. The printing apparatus eliminates the need for dedicated power for driving the sorting mechanism, thereby reducing cost and size of the printing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-279317, filed Dec. 9, 2009, which is hereby incorporated by reference herein in its entirety.

What is claimed is:

1. A recording apparatus that conveys recording sheets, records on the recording sheets, discharges the recording sheets, and sorts the discharged recording sheets, comprising:
a movable carriage that holds a recording head for recording on the recording sheets; and
a sorting mechanism that controls positions of the recording sheets so that the discharged recording sheets are sorted,
wherein the sorting mechanism is configured to be operated by the carriage and sort the recording sheets in accordance with a position of the carriage.

2. The recording apparatus according to claim 1, wherein the sorting mechanism includes an abutment portion against which the carriage abuts, and
the sorting mechanism is configured to be moved together with the recording sheet orthogonally to a conveying direction of the recording sheet by the carriage pressing the abutment portion.

3. The recording apparatus according to claim 1, wherein the sorting mechanism includes an abutment portion against which the carriage abuts, and
the sorting mechanism is configured to be pivoted together with the recording sheet around a pivot shaft orthogonal to the recording sheet by the carriage pressing the abutment portion.

4. The recording apparatus according to claim 1, wherein the sorting mechanism includes a conveying mechanism including a pair of conveying rollers that hold and convey the recording sheet.

5. The recording apparatus according to claim 4, further comprising a control unit that controls so that the carriage operates the sorting mechanism between when the recording head held by the carriage records on the recording sheet and when the recording sheet is discharged.

6. The recording apparatus according to claim 1, wherein the sorting mechanism includes a supplying stacking mechanism that stacks and holds the recording sheet before conveyed.

7. The recording apparatus according to claim 6, further comprising a control unit that controls so that the carriage operates the sorting mechanism and changes a conveying position of the recording sheet when the recording sheet is conveyed from the supplying stacking mechanism.

8. The recording apparatus according to claim 7, wherein the control unit controls so that a recording area where the recording head held by the carriage records is changed in accordance with an amount of change of the conveying position of the recording sheet.

9. The recording apparatus according to claim 1, wherein the sorting mechanism includes a discharging stacking mechanism that stacks and holds the discharged recording sheet,
the discharging stacking mechanism includes an abutment portion against which the carriage abuts, and
the discharging stacking mechanism is configured to be moved orthogonally to the conveying direction of the recording sheet by the carriage pressing the abutment portion.

10. The recording apparatus according to claim 9, further comprising a control unit that controls so that the carriage operates the sorting mechanism between when the recording head held by the carriage records on the recording sheet and when the recording sheet is discharged.

11. The recording apparatus according to claim 1, wherein the recording head records on the recording sheet with the movement of the carriage, and
the recording apparatus further comprises a lock mechanism that secures the sorting mechanism inoperably in a predetermined reference position during a recording operation.

12. The recording apparatus according to claim 11, wherein the lock mechanism is operated by the carriage, and makes the sorting mechanism operable in accordance with a position of the carriage.

13. The recording apparatus according to claim 12, wherein the lock mechanism makes the sorting mechanism operable when the carriage is located outside a first position, which is outside a recording area where the recording head records on the recording sheet, and the sorting mechanism is operated when the carriage is located further outside a second position, which is outside the first position.
